(19) United States
(12) Patent Application Publication
(10) Pub. No.: US 2005/0095081 A1
(43) Pub. Date: May 5, 2005

(54) Expandable screw cover

(76) Inventors: Ying Liang Tu, Shenzhen (CN); Xinghuang Luo, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/921,375

(22) Filed: Aug. 18, 2004

(30) Foreign Application Priority Data
Nov. 4, 2003 (TW) 92219540

(51) Int. Cl. F16B 1/00

(52) U.S. Cl. 411/372.6

(57) ABSTRACT

A screw cover (100) includes a cap (10) made of stretchable material, and a post (20) covered by the cap. The cap includes an end (12) having a round opening (122). A diameter of the end is slightly less than or the same as a diameter of a screw hole (32). The post includes a top column (22). A diameter of the top column is slightly greater than a diameter of the opening, so that the post is engaged in the opening. The diameter of the end is thus expanded to be slightly greater than the diameter of the screw hole, so that the screw cover can be secured in the screw hole. In disassembly, the top column is pushed so that the post moves down, and the diameter of the end returns to its original size. The screw cover can then be easily dropped out from the screw hole.

### BACKGROUND OF THE INVENTION

1. Field of the Invention

The present invention generally relates to screw covers, and more particularly to a screw cover for a portable electronic device. The invention relates to a contemporarily filed application titled “SCREW CAP FOR A PORTABLE ELECTRONIC DEVICE” and having the same assignee with the instant invention.

2. Prior Art

Currently, screw covers are widely used in electronic apparatuses including portable electronic devices in order to keep screws hidden. An example is found in the mobile phone model no. N188 marketed by Samsung Company. The mobile phone includes a columnar screw cover. The screw cover is made of plastic, and is set in a screw hole over a screw. The diameter of the screw cover is slightly greater than that of the screw hole, so that the screw is blocked from accidentally coming out from the screw hole. However, in disassembly, it is difficult to prise the screw cover out, and the screw cover can be easily damaged or even destroyed in this process.

Therefore, a screw cover which is easily assembled and disassembled is desired.

### SUMMARY OF THE INVENTION

Accordingly, an object of the present invention is to provide a screw cover which is conveniently assembled and disassembled.

To achieve the above-mentioned object, a screw cover of the present invention is for being secured in a screw hole of a mobile phone. The screw cover comprises a cap made of stretchable material, and a post coaxially covered by the cap. The cap comprises an end having a round opening. A diameter of the end is slightly less than or the same as a diameter of the screw hole. The post comprises a top column. A diameter of the top column is slightly greater than a diameter of the round opening, so that the post is engaged in the round opening in assembly. The diameter of the end is thus expanded to be slightly greater than the diameter of the screw hole, so that the whole screw cover can be securely fixed in the screw hole. In disassembly, the top column is pushed so that the post moves down, and the diameter of the end returns to its original size. The screw cover can then be easily dropped out from the screw hole. The screw cover fully utilizes interengaging structures of the cap and the post and the elasticity of the cover. This makes assembly and disassembly of the screw cover quick and convenient.

Other objects, advantages and novel features of the invention will become more apparent from the following detailed description when taken in conjunction with the accompanying drawings, in which:

### BRIEF DESCRIPTION OF THE DRAWINGS

FIG. 1 is an isometric view of a screw cover in accordance with a preferred embodiment of the present invention, the screw cover comprising a central post and an outer cap;

FIG. 2 is an exploded, isometric view of the screw cover of FIG. 1, viewed from another aspect;

FIG. 3 is essentially a cross-sectional view of the screw cover of FIG. 1 secured in a mobile phone; and

FIG. 4 is similar to FIG. 3, but showing the post disengaged from the cap.

### DETAILED DESCRIPTION OF THE INVENTION

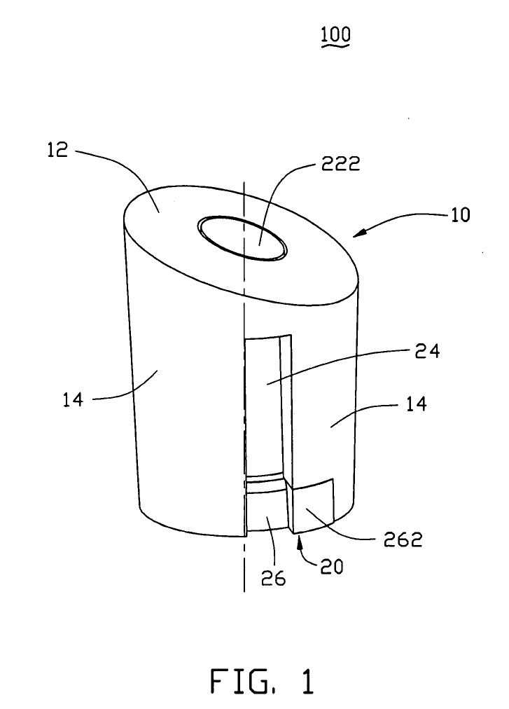

Referring to FIG. 1, a screw cover 100 in accordance with the preferred embodiment of the present invention includes a cap 10 made from a kind of stretchable material such as plastic, and a post 20. The post 20 is contained in the cap 10, with the cap 10 and the post 20 being coaxial.

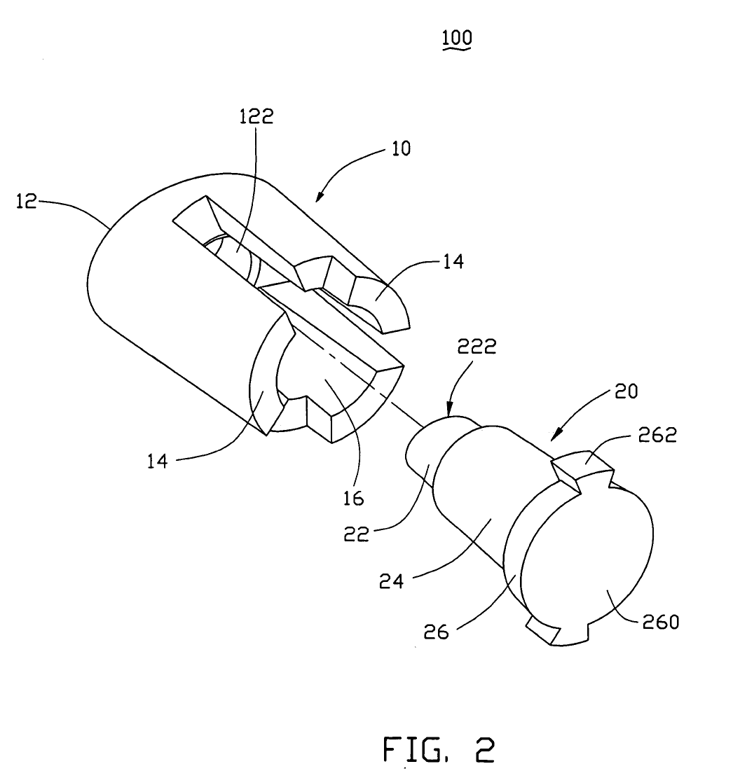

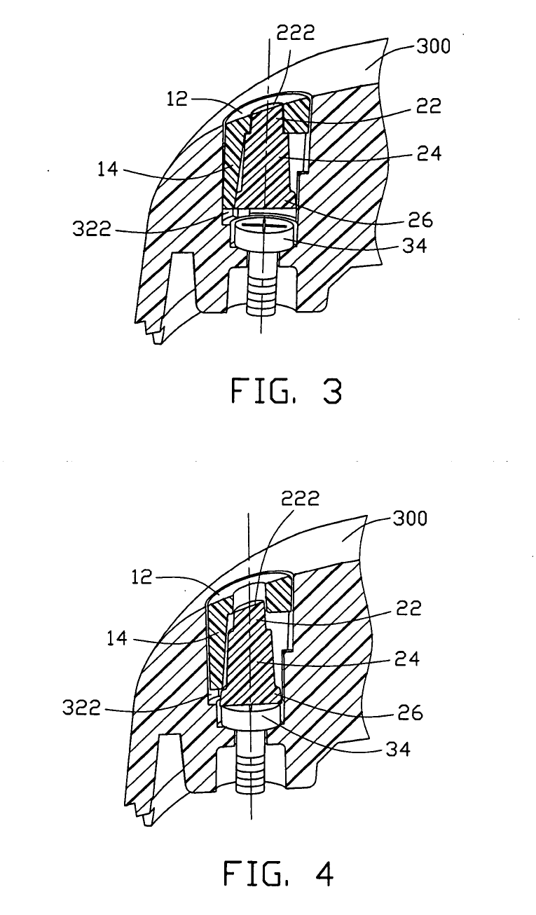

Referring also to FIGS. 2 and 3, the cap 10 includes an end 12 with a round opening 122 therein, three arms 14 extending from the end 12, and a columniform chamber 16 defined therein by the end 12 and the three arms 14. A diameter of the end 12 is slightly less than or the same as a diameter of a screw hole 32 of a mobile phone 300. A distance is defined between each two adjacent of the three arms 14. Two of three arms 14 each defines a recess 142 distal from the end 12, the recesses 142 being approximately opposite each other.

The post 20 includes a base 26, a middle column 24 extending from the base 26, and a top column 22 extending from the middle column 24. The base 26, the middle column 24, and the top column 22 are coaxial. The base 26 includes a main body 260, and two wedges 262 extending from approximately opposite sides of the main body 260 respectively. A diameter of the main body 260 is slightly greater than a diameter of the chamber 16. A diameter of the middle column 24 is less than the diameter of the main body 260, and greater than a diameter of the opening 122. The top column 22 includes an exposed surface 222. The diameter of the top column is less than the diameter of the middle column 24, and slightly greater than the diameter of the opening 122.

Referring to FIGS. 1 and 3, when the screw cover 100 is used in the mobile phone 300, the top column 22 is fixed in the opening 122, and the wedges 262 are fixed in the recesses 142. Thus the post 20 is neatly and firmly surrounded by the cap 10, with the post 20 and the cap 10 being coaxial. The end 12 is expanded to be slightly larger than its original size, and the arms 14 are slightly splayed out and hold the post 20. That is, an outer diameter of the cap 10 is uniformly slightly larger than a diameter of the screw hole 32 of the mobile phone 300. So the screw cover 100 can be securely fixed in the screw hole 32 over a screw 34, with the base 26 of the post 20 facing the screw 34. A space 322 is defined between the screw cover 100 and the screw 34.

In disassembly, the post 20 is pressed down partly in the space 322 between the screw 34 and the screw cover 100. The outer diameter of the cap 10 returns to its original size, which is smaller than the diameter of the screw hole 32. Then when the mobile phone 300 is inverted, the cap 10 and the post 20 can be easily dropped out from the screw hole 32.

From the above description, it can be seen that the screw cover 100 of the present invention fully utilizes the interengaging structures of the cap 10 and the post 20 and the elasticity of the cap 10. This makes assembly and the disassembly of the screw cover 100 quick and convenient.

It is believed that the present invention and its advantages will be understood from the foregoing description, and it will be apparent that various changes may be made thereto without departing from the spirit and scope of the invention or sacrificing all of its material advantages. The example herein before described is merely a preferred or exemplary embodiment of the invention.

1. A screw cover for covering a screw in a screw hole, comprising:
a cap made of stretchable material, comprising an end having a round opening; and
a post coaxial with the cap, the post comprising a top column engaged in the round opening;
wherein a diameter of the cap is the same as or slightly less than a diameter of the screw hole, and a diameter of the post is slightly greater than a diameter of the round opening.

2. The screw cover as claimed in claim 1, wherein the cap further comprises a plurality of arms extending from the end thereof, and the cap defines a chamber therein, a diameter of the chamber is slightly less than the diameter of the post, and the post is received in the chamber and held by the arms.

3. The screw cover as claimed in claim 2, wherein the post further comprises a middle column and a base, a diameter of the middle column is greater than the diameter of the round opening and greater than a diameter of the top column and less than diameter of the base, and the diameter of the base is slightly greater than the diameter of the chamber.

4. The screw cover as claimed in claim 3, wherein each of the arms defines a recess, with the recesses disposed generally opposite each other, and the base comprises a main body and a plurality of wedges extending from the main body, with the wedges disposed generally opposite each other, and the wedges are engaged in the recesses.

5. A combination of a screw installation structure, comprising:
a hole embedded in a surface of a housing;
a screw located at a bottom end of the hole;
a screw cover disposed in the hole and including:
a center piece engageably surrounded by a circumferential piece; wherein when said center piece is located in a first position relatively closer to the surface of the housing, the screw cover essentially provides a top face flush with the surface of the housing and the circumferential piece urged by the center piece to interfere with an interior surface of the hole for retaining the screw cover in position in the hole; when said center piece is located in a second position relatively farther from the surface of the housing, the circumferential piece is released from the center piece and thus no longer interferes with the interior surface of the hole so as to allow the screw cover to removed from the hole.

6. The combination as claimed in claim 5, wherein said center piece and said circumferential piece are discrete from each other.

7. The combination as claimed in claim 5, wherein when said center piece is located in the second position, the top face forms a recess therein above said center piece.

8. A method of covering a screw on a housing wherein said housing defines a hole extending inwardly from a surface thereof and said screw is located under said hole, comprising at least one step of:
providing a first piece cooperating with a second piece to commonly form a screw cover to be received in the hole above said screw; wherein
said second piece is urged by the first piece to be retainably engaged with an interior surface of the hole when said first piece is located in a first position along an axial direction of the hole; said second piece is released from the first piece not to be retainably engaged with the interior surface of the hole when said first piece is located in a second position along said axial direction of the hole, so as to allow the screw cover to be removed from the hole.

9. The method as claimed in claim 8, wherein said second piece surrounds said first piece.

10. The method as claimed in claim 8, wherein said first position is closer to the surface than the second position.

11. The method as claimed in claim 8, wherein said first piece and said second piece are discrete from each other.

12. The method as claimed in claim 8, wherein said second piece interferes with the interior surface of the hole when said first pieced is located in the first position.

13. The method as claimed in claim 12, wherein said first piece interferes with the interior surface of the hole when said first piece is located in the first position.
